(19) United States
(12) Patent Application Publication
(10) Pub. No.: US 2015/0066977 A1
(43) Pub. Date: Mar. 5, 2015

(54) METHOD AND SYSTEM FOR MANAGING DIGITAL RESOURCES

(71) Applicants: Peking University Founder Group Co., Ltd., Beijing (CN); Beijing Founder Electronics Co., Ltd., Beijing (CN); Founder Information Industry Group, Beijing (CN)

(72) Inventors: Weilong WEN, Beijing (CN); Shaoming LI, Beijing (CN)

(73) Assignees: Peking University Founder Group Co., Ltd., Beijing (CN); Beijing Founder Electronics Co., Ltd., Beijing (CN); Founder Information Industry Group, Beijing (CN)

(21) Appl. No.: 14/093,837

(22) Filed: Dec. 2, 2013

(30) Foreign Application Priority Data
Aug. 29, 2013 (CN) 201310384994.7

(51) Int. Cl. G06F 17/30

(52) U.S. Cl. CPC G06F 17/30477
USPC 707/769

(57) ABSTRACT

Embodiments of the present invention provide a method and a system for managing digital resources. The method comprises: providing a configuration interface to a user; receiving configuration information inputted by the user via the configuration interface, wherein the configuration information may comprise a document type, an application operation, and an attribute field application; setting up a resource document library according to the resource document type; setting up a resource application template according to the application operation and the attribute field application; invoking the data from the resource document library by using the resource application template.

### BACKGROUND OF THE INVENTION

1. Field of the Invention

The embodiments of the present invention relates to the digital publishing field, and especially to a system and a method for managing digital resources.

2. Description of the Prior Art

At present, individual requirements with respect to resource types and individual application requirements based on different fields in the resource library from a user are usually fulfilled by modifying storage structures of the resources or modifying programs used for accessing the resources. And the specific steps may be:

step 1, a developer may collect requirements regarding resource storage structure from the user, and define a document type field according to the requirements, and store the document type field according to the resource type, so that the same type resource may be reused.

step 2, the developer may set up a resource library table according to the document type field of the resource.

step 3, the developer may collect individual requirements with respect to the attribute field of different applications from the user, and write new applications and new resource data query statements.

If modifying is required based on the requirements of the current user, then the system developer has to deploy a new resource base and corresponding application program for the user again, and backup the original resource data and recover the original resource data into the new resource storage library.

In the digital resource management system according to the above method, the system developer has to establish close contacts and good cooperation, the developing costs are high and the reusability is poor.

### SUMMARY OF THE INVENTION

The purpose of embodiments of the present invention is to provide a system and a method for digital resource management, which may flexibly configure the storage of digital resource and the corresponding application management visually, and thus the reusability of the system can be improved.

Accordingly, an embodiment of the present invention may provide:

a method for managing digital resources, comprising:

providing a configuration interface to a user;

receiving configuration information inputted by the user via the configuration interface, wherein the configuration information may comprise a resource document type, an application operation, and an attribute field application;

setting up a resource document library according to the resource document type;

setting up a resource application template according to the application operation and the attribute field application; and

retrieving data from the resource document library by using the resource application template.

Preferably, the providing a configuration interface to a user may comprise:

providing configuration interfaces corresponding to resource document type, the application operation, and the attribute field application respectively to the user.

Preferably, the method may further comprise:

providing a resource document library modification interface to the user;

receiving modification information with respect to the resource document type and/or the document type field inputted by the user via the resource document library modification interface;

synchronizing the modification information with the resource document library.

Preferably, the synchronizing the modification information into the resource document library may comprise:

generating a pseudo SQL statement according to the modification information;

converting the pseudo SQL statement into a query statement of the resource document library;

modifying a structure of a data table in the resource document library by using the query statement.

Preferably, the retrieving the data from the resource document library by using the resource application template may comprise:

retrieving data from the resource document library according to the resource document library and the document chosen by the user;

packaging the data into an object; and

invoking the object by using a page display template, so as to implement displaying with respect to the data in the object.

Another embodiment of the present invention also provides a system for managing digital resources, comprising:

a configuration module, configured to provide a configuration interface to the user, and to receive the configuration information inputted by the user via the configuration interface, wherein the configuration information may comprise a resource document type, an application operation and an attribute field application;

a document library setting up module, configured to set up a resource document library according to the resource document type;

a template setting up module, configured to set up a resource application template according to the application operation and the attribute field application; and

an application module, configured to retrieve data from the resource document library by using the resource application template.

Preferably, the configuration module may be used for providing a configuration interface corresponding to each of the resource document type, the application operation, and the attribute field application respectively to the user.

Preferably, the system may further comprise:

a document modification module, configured to provide a resource document library modification interface to the user, and to receive modification information with respect to the resource document type and/or the document type field inputted by the user via the resource document library modification interface; and

a synchronizing module, configured to synchronize the modification information with the resource document library.

Preferably, the synchronizing module may comprise:

a statement generation unit, configured to generate a pseudo SQL statement according to the modification information;

a statement conversion unit, configured to convert the pseudo SQL statement into a query statement of the resource document library; and

a modification unit, configured to modify a structure of a data table in the resource document library by using the query statement.

Preferably, the application module may comprise:

a data retrieving unit, configured to retrieve data from the resource document library according to the resource document library and the document chosen by the user;

a data packaging unit, configured to package the data into an object; and

a data displaying unit, configured to invoke the object by using a page display template, so as to implement displaying with respect to the data in the object.

In addition, another embodiment of the present invention also provide a non-transient storage media storing a program for performing a method for managing digital resources, so as to cause a computer to invoke the program stored in the non-transient storage media to carry out the above method.

The system and method for managing digital resources according to the embodiments of the present invention may configure a management platform based on a unified attribute field, and store structures and resource applications with respect to different resources, configure fields used for storage and specific application visually, automatically generate a resource library and a resource application template, and retrieve the data from the resource document library by using the resource application template. Hence. the system and method for managing digital resources according to the embodiments of the present invention may write the obtained different resource data into different resource application templates via reusable operation components, thus realizing applications regarding to different data processing aspects. The method and system are adaptable, and do not require personalized developing respectively with respect to different requirements from different users, and the user may implement application requirements only by configuring the corresponding information according to the user's own requirements.

### BRIEF DESCRIPTION OF THE DRAWINGS

FIG. 1 is a flowchart illustrating a method for managing digital resources according to an embodiment of the present invention;

FIG. 2 is a diagram illustrating a document type management interface provided to a user according to an embodiment of the present invention;

FIG. 3 is a diagram illustrating an operation management interface provided to a user according to an embodiment of the present invention;

FIG. 4 is a diagram illustrating an attribute resource application configuration interface provided to a user according to an embodiment of the present invention;

FIG. 5 is a diagram illustrating a modification interface of the resource document library provided to a user according to an embodiment of the present invention;

FIG. 6 is a diagram illustrating a working platform provided to a user according to an embodiment of the present invention;

FIG. 7 is a diagram illustrating a system for managing digital resources according to an embodiment of the present invention; and

FIG. 8 is another diagram illustrating a system for managing digital resources according to an embodiment of the present invention.

### DETAILED DESCRIPTION OF THE PREFERRED EMBODIMENTS

Next, an embodiment of the present invention will be described in detail, in connection with the drawings, to help the skilled in this art understand solutions of the embodiments of the present invention.

With respect to the problem that it is required to develop a system for managing digital resources for different users respectively in the prior arts, which has reduced the reusability of the system for managing digital resources, an embodiment of the present invention provides a system and a method for managing digital resources, so as to form a customized system for managing resources and the specific process may be that, configuring a management platform based on a unified attribute field, and storing structures and resource applications with respect to different resources, configuring fields used for storage and specific application visually, automatically generating a resource library and a resource application template, and retrieving data from the resource document library by using the resource application template.

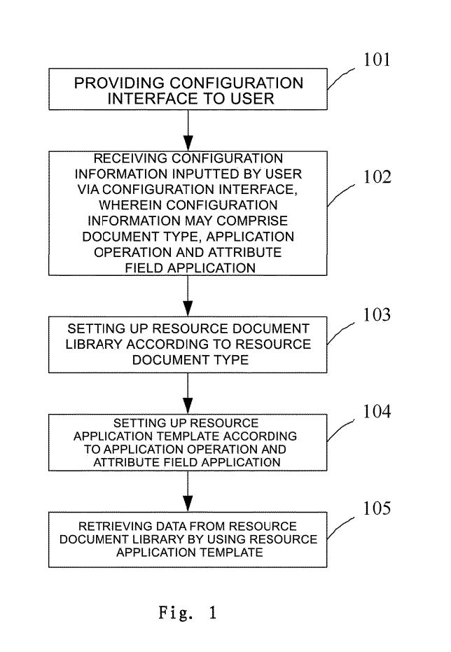

As shown in FIG. 1, a flowchart illustrating a method for managing digital resources according to an embodiment of the present invention, comprising:

Step 101, providing a configuration interface to a user.

Step 102, receiving configuration information inputted by the user via the configuration interface, wherein the configuration information may comprise a resource document type, an application operation, and an attribute field application.

Specifically, a corresponding configuration interface may be provided with respect to different configurations, respectively.

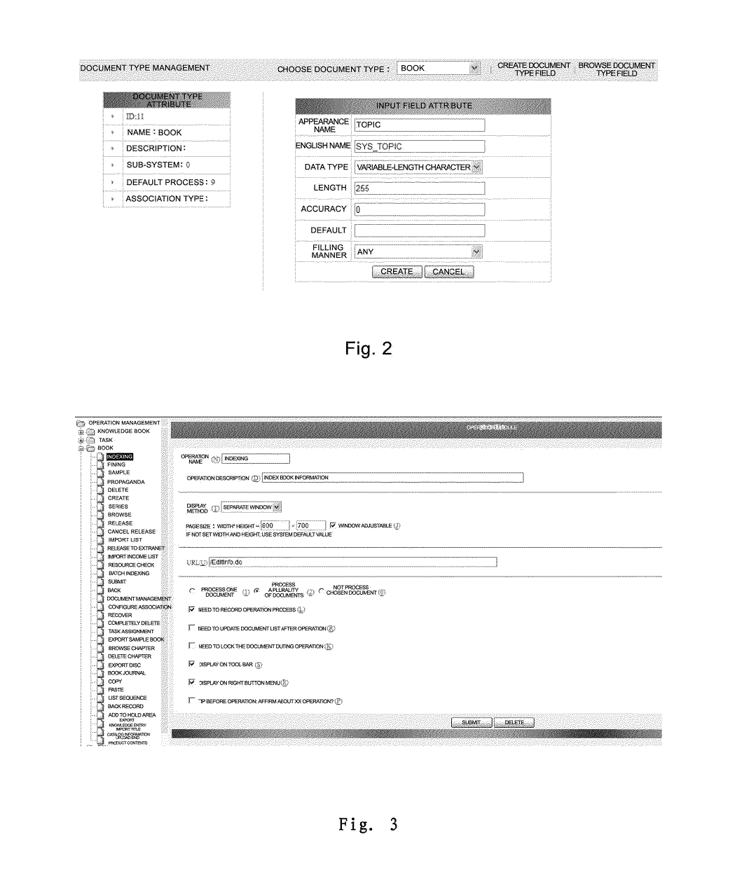

FIG. 2 is a diagram illustrating a document type management interface provided to a user according to an embodiment of the present invention.

Here, the resource document type and the new document type field are used for generating and managing a metadata. The metadata refers to a metadata in a data table, while the document type field refers to a document type field of the data table. The name, type and length of a field may be flexibly defined when generating a document type field.

As shown in FIG. 2, the name, type and length of a field may be flexibly defined when generating a document type field.

Different database dialects may be used to implement the compatibility among various databases, such as SQL SERVER and ORACLE by a backstage.

FIG. 3 is a diagram illustrating an operation management interface provided to a user according to an embodiment of the present invention.

In an embodiment of the present invention, an operation on a resource document may be customized, as shown in FIG. 3, indexing, fining, deleting and creating and so on may be configured to the document type “book”; and a user may configure a size of a page for displaying, a number of documents for processing and a displaying location for an operation or the like.

A developer is required to provide only a URL address or an interface for operation access.

Note that, in an embodiment of the present invention, via a configuration on an application operation, a programmer is required only to write one processing implementation with respect to a resource document, and then a displaying form of a page and an effective range of the operation may be realized via a configuration. The detailed information of the operation may be recorded in the database, and may be flexibly applied to (or synchronized with) different document libraries via the configuration. The same operation may be used for different document libraries, such as indexing being used for almost all the document libraries.

The configuration of an application operation allows writing only one processing class for an indexing operation by a programmer, without writing each of different indexing operation processing categories for each of different document libraries, and without modifying a code of each display interface of a document library by adding a link of the indexing operation. The displaying form of an application operation in different libraries may be realized via a configuration library. Normally, different parameters may be transferred to the processing class of this operation from different document libraries (normally including, a document library ID and a document ID), the programmer only needs to obtain these parameters from a backstage class and perform different processing according to different service logics.

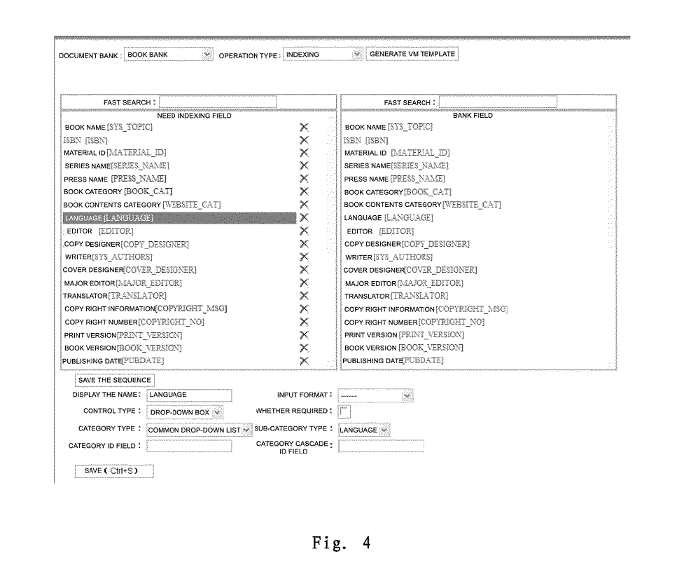

FIG. 4 is a diagram illustrating an attribute resource application configuration interface provided to a user according to an embodiment of the present invention.

In an embodiment of the present invention, in actual operation on a document, there may be specific displaying or operation requirements such as year and area. In the embodiment of the present invention, various operation methods such as a classification tree, a drop-down box, a text box, a single choice, a multiple choice and so on, each of which may be flexibly configured according to the document type field. For example, the indexing may be used to configure that a control type to be used is a text box or a drop-down box, and a list may be used to configure a number of documents displaying on one page and a number of pages to be cached. These configuration information may be stored in the database after saving, and it may be determined directly that an SQL statement being combined when a corresponding application being retrieved will inquire which field there are, and putting an inquiry result into an object of a developing language or combining the inquiry result with one temporary fragment of an XML data file.

In an embodiment of the present invention, an operation configured in the attribute field application is not limited to a specific resource document type, each operation is performed with respect to a field, and the same operation may be applied to various resource document types. Furthermore, in an attribute field application configuration, there may be some targeted configuration contents with respect to different operation applications, thus improving the generating of a resource application template (such as a displaying template). For example, the indexing application may be used to choose whether a field is required to be filled out, the displaying name of a field and the inputting method of a field (such as a text box, a drop-down box, a date control and so on). Another example is that, a list application may be used to choose a number of resource documents displaying on one page, a sequence field of the list, and etc. The system may generate a corresponding resource application template automatically for the displaying of different applications.

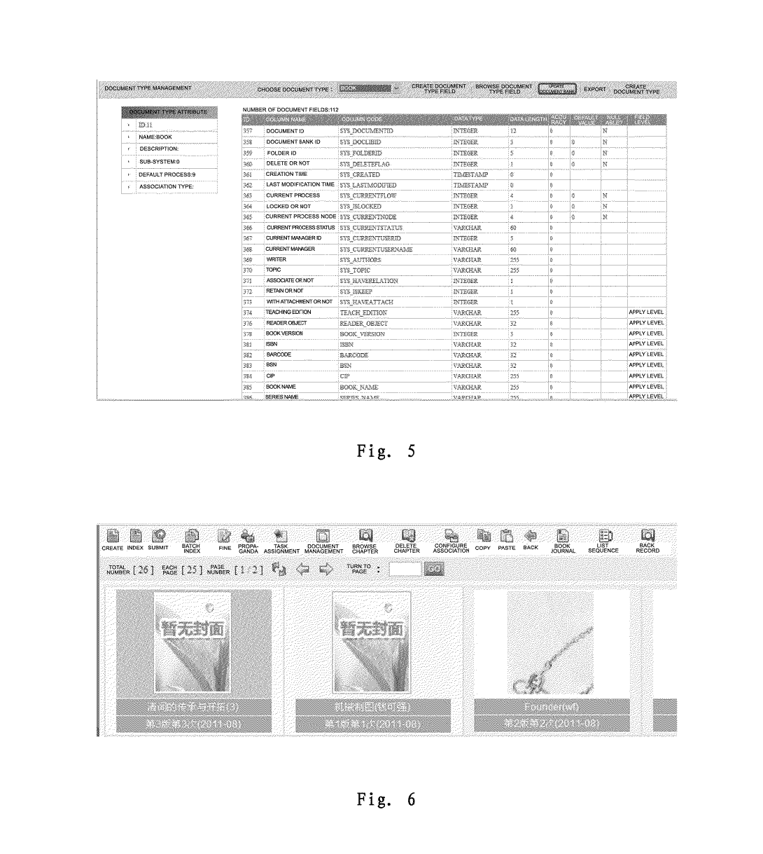

Note that, in an embodiment of the present invention, a modification interface of the resource document library may be provided to a user, as shown in FIG. 5.

After receiving modification information with respect to the resource document type and/or the document type field inputted by a user via the modification interface of the resource document library, the modified information may be synchronized with the resource document library.

In this way, if a user needs to modify a database structure, it is required only to add, delete, modify the document type field via the visualized storage configuration management platform of the attribute field, and then to replicate the same into the database.

Step 103, setting up a resource document library according to the resource document type.

In an embodiment of the present invention, a resource document may be stored in the form of database.

The document type field of the resource document library has been defined by a user, thus the actual resource document library only needs to be created based on one document type or to be synchronized with the resource document library. It is not required to redefine a resource document library field when creating a resource document library. Instead, a dynamic statement for library setting up may be combined based on one document type, and a plurality of resource document libraries may be created rapidly. At this time, the document type may be equivalent to a template for creating the resource document library.

Step 104, setting up a resource application template according to the application operation and the attribute field application.

Take an example of generating a template of indexing, in practical applications, “Velocity” template technology may be used. “Velocity” is a template engine (the use of a template engine is to obtain, process and at last display data) based on JAVA. It allows citing an object defined by JAVA code simply by using a template language by anyone.

When a text box or a drop-down box inputting is chosen for a certain field, the system may obtain a field name from the database, and obtain a template of a specified input component, and then combine the field name with the attributes such as name, ID and value of the current input component and so on. And these small input components may be put into a well defined original page template according to a predetermined field sequence, and combined into a complete page template complying with requirements.

For example, a code fragment of book name text box input control is as follows, wherein bold parts are the contents to be combined by the system:

```
  <!--book name-->
  <td align=“right”>
  <span id= “CTRL_SYS_TOPIC”
required= “$fieldMap.SYS_TOPIC.required”
title=
“$fieldMap.SYS_TOPIC.fieldName”>$fieldMap.SYS_TOPIC.fieldname</span>:&amp;nbsp;&amp;nbs
p;
</td>
<td>
<input name= “SYS_TOPIC” id= “SYS_TOPIC” type= “text”
Value= “$!fieldValueMap.SYS_TOPIC”/>
</td>
```

The resource application template may be generated according to different configurations on the management platform by the user. In a practical application, the code of a display layer actually concerning the service logic on the page may be designed within the resource application template.

The code of the resource application template may be stored in the form of an XML file. When retrieving the data from the resource document library, the system may read different code fragments from the XML file according to choices of the user, and combine these code fragments into a meaningful web page code which can realize a certain function.

Step 105, retrieving the data from the resource document library by using the resource application template.

Specifically, according to a resource document library and a document chosen by a user, data may be retrieved from the resource document library, and packaged into an object; by invoking the object by using the page display template, displaying of the data in the object may be realized. For example, applications such as displaying of the resources as a list, searching of the resources and indexing of the resources and so on.

In a practical application, one working platform interface may be provided to the user; and the applications of this working platform may display on a tool bar of the working platform in a centralized way, as shown in FIG. 6.

Take indexing as an example, when selecting one or more documents and clicking on an indexing operation, the resource document library ID and the document ID(s) may be transferred as parameters to a data dispatching class. And the data dispatching class may translate the transferred resource document library ID to obtain a corresponding document type, and obtain a field needed to be read according to the correspondence between a field and an operation configured in the attribute field application. And then it may combine an SQL statement such as “SELECT field name FROM library ID WHERE SYS_DOCUMENTID=document ID” with these fields, such as the resource document library ID and the document ID(s), so as to read data from the library, and the read data may be packaged into a JAVA object. In this way the resource application template generated in step 104 may read data from the object directly, which realizes various applications, such as the indexing of the working platform.

From the above description it can be seen that, the resource management method according to an embodiment of the present invention can significantly improve the flexibility and reusability of resource management. A user may flexibly configure the method of resource storage and resource application according to requirements of the user. When a requirement of the user in the attribute field changes, there is no need for secondary developing by the developer, or modifying the structure of the data table manually.

Accordingly, a system for managing digital resources may be further provided by an embodiment of the present invention, as shown in FIG. 7 for example.

In this embodiment, the system may comprise:

a configuration module 701, configured to provide a configuration interface to a user, and to receive configuration information inputted by the user via the configuration interface, wherein the configuration information comprises a resource document type, an application operation and an attribute field application;

a document library setting up module 702, configured to set up a resource document library according to the resource document type;

a template setting up module 703, configured to set up a resource application template according to the application operation and the attribute field application; and

an application module 704, configured to retrieve data from the resource document library by using the resource application template.

Here, the configuration module 701 may provide a configuration interface corresponding to the document type, the application operation, and the attribute field application respectively, and for details, please see the above description for the digital resource management according to an embodiment of the present invention, which is omitted here.

Specifically the application module 704 may include a data retrieving unit, a data packaging unit, and a data displaying unit. Wherein:

the data retrieving unit may be configured to retrieve data from the resource document library according to a resource document library and a document chosen by the user;

the data packaging unit may be configured to package the data into an object;

the data displaying unit may be configured to retrieve the object by using a page display template, so as to implement displaying with respect to the data in the object.

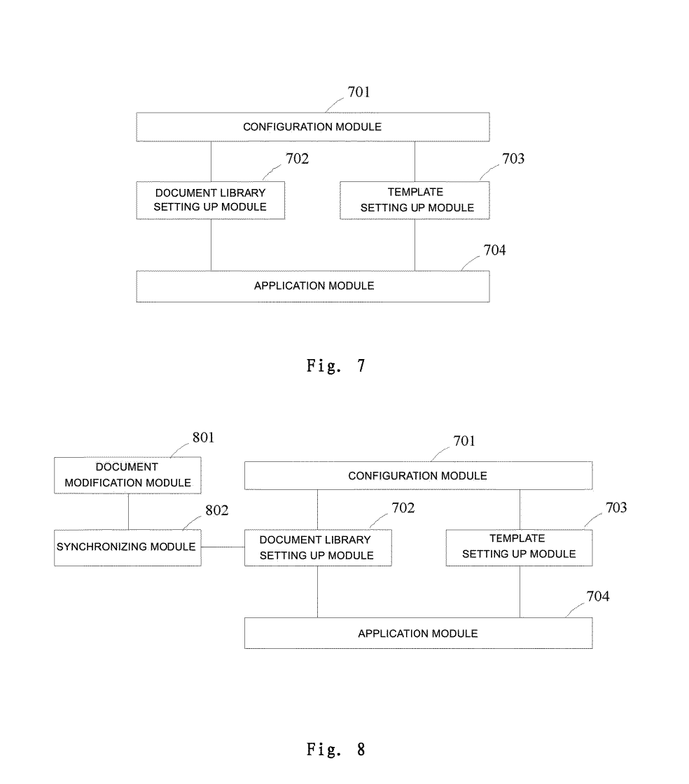

Further, to facilitate the user for modifying the resource document library, as shown in FIG. 8, the system for managing digital resources according to the embodiment of the present invention may further include:

a document modification module 801, configured to provide a resource document library modification interface to the user, and to receive modification information with respect to the document type and/or the document type field inputted by the user via the resource document library modification interface;

a synchronizing module 802, configured to synchronize the modification information with the resource document library.

In a practical application, the synchronizing module 802 may include a statement generation unit, a statement conversion unit and a modification unit. Wherein:

the statement generation unit may be configured to generate a pseudo SQL statement according to the modification information;

the statement conversion unit may be configured to convert the pseudo SQL statement into a query statement of the resource document library. For example, the statement conversion unit may convert the pseudo SQL statement into an ALTER query statement of the resource document library by using a data dialect using HIBERNATE framework;

the modification unit may be configured to modify a structure of a data table in the resource document library by using the query statement.

The system for managing digital resources according to the embodiment of the present invention may configure a management platform based on a unified attribute field, store structures and resource applications with respect to different resources, configure fields used for storage and specific application visually, automatically generate a resource library and a resource application template, and retrieve data from the resource document library by using the resource application template. The system and method for managing digital resources according to the embodiments of the present invention may write the obtained different resource data into different resource application templates via reusable operation components, thus realizing applications regarding to different data processing aspects. The system is adaptable, and does not require customized developing respectively with respect to different requirements from the user. And the user may implement application requirements only by configuring the corresponding information according to the user's own requirements.

The embodiments of the present invention have been described in a progressive way, and same or similar parts may be described by referring to one another. The emphasis of each embodiment is only the differences from other embodiments. Especially, the system embodiment has been described relatively in a simple manner because that the system embodiment is basically similar to the method embodiment, so the corresponding parts may be described by referring to same parts of the method embodiment.

It should be understood by the skilled in this art that, the above mentioned each module and step of the present invention may be realized via a general-purpose computer apparatus. For example, the contents displayed via the work platform operation application may be realized by using a JAVA object plus a template, or by using an XML data source plus an XSLT conversion template. The attribute field storage configuration module, the attribute field application configuration module and the work platform application display module or the like may be deployed on a single computing apparatus in a centralized way, or separately deployed in a network formed by a plurality of computing apparatuses. Optionally, they may be realized by using program codes which can be executed by a computing apparatus, thus they may be stored in a storage apparatus and to be executed by the computing apparatus. Or, they may be made into IC modules respectively, or a plurality of the modules or steps may be made into a single IC module. In this way, the present invention is not limited to any specific combination of hardware and software.

The above description is only preferred embodiments of the present invention and the present invention is not limited thereto. Any modification, equivalent replacement, and improvement made under the spirit and principle of the present invention should fall into the protection scope of the present invention.

What is claimed is:

1. A method for managing digital resources, comprising:
providing a configuration interface to a user;
receiving configuration information inputted by the user via the configuration interface, wherein the configuration information comprises a resource document type, an application operation, and an attribute field application;
setting up a resource document library according to the resource document type;
setting up a resource application template according to the application operation and the attribute field application; and
retrieving data from the resource document library by using the resource application template.

2. The method according to claim 1, wherein the providing a configuration interface to a user comprises:
providing configuration interfaces corresponding to resource document type, the application operation, and the attribute field application respectively to the user.

3. The method according to claim 1, further comprising:
providing a resource document library modification interface to the user;
receiving modification information with respect to the resource document type and/or the document type field inputted by the user via the resource document library modification interface; and
synchronizing the modification information with the resource document library.

4. The method according to claim 3, wherein the synchronizing the modification information with the resource document library comprises:
generating a pseudo SQL statement according to the modification information;
converting the pseudo SQL statement into a query statement of the resource document library; and
modifying the structure of a data table in the resource document library by using the query statement.

5. The method according to claim 1, wherein the retrieving data from the resource document library by using the resource application template comprises:
retrieving data from the resource document library according to the resource document library and the document chosen by the user;
packaging the data into an object; and
invoking the object by using a page display template, so as to implement displaying with respect to the data in the object.

6. A system for managing digital resources, comprising:
a configuration module, configured to provide a configuration interface to the user, and to receive the configuration information inputted by the user via the configuration interface, wherein the configuration information comprises a resource document type, an application operation and an attribute field application;
a document library setting up module, configured to set up a resource document library according to the resource document type;
a template setting up module, configured to set up a resource application template according to the application operation and the attribute field application; and
an application module, configured to retrieve data from the resource document library by using the resource application template.

7. The system according to claim 6, wherein the configuration module is used for providing configuration interfaces corresponding to the resource document type, the application operation, and the attribute field application respectively to the user.

8. The system according to claim 6, further comprising:
a document modification module, configured to provide a resource document library modification interface to the user, and to receive modification information with respect to the resource document type and/or the document type field inputted by the user via the resource document library modification interface; and
a synchronizing module, configured to synchronize the modification information with the resource document library.

9. The system according to claim 8, wherein the synchronizing module comprises:
a statement generation unit, configured to generate a pseudo SQL statement according to the modification information;
a statement conversion unit, configured to convert the pseudo SQL statement into a query statement of the resource document library; and
a modification unit, configured to modify the structure of a data table in the resource document library by using the query statement.

10. The system according to claim 6, wherein the application module comprises:
a data retrieving unit, configured to retrieve data from the resource document library according to the resource document library and the document chosen by the user;
a data packaging unit, configured to package the data into an object; and
a data displaying unit, configured to invoke the object by using a page display template, so as to implement displaying with respect to the data in the object.

11. A non-transient storage media storing a program for performing a method for managing digital resources, so as to cause a computer to invoke the program stored in the non-transient storage media to carry out the following steps:
providing a configuration interface to a user;
receiving configuration information inputted by the user via the configuration interface, wherein the configuration information comprises a resource document type, an application operation, and an attribute field application;
setting up a resource document library according to the resource document type;
setting up a resource application template according to the application operation and the attribute field application; and
retrieving data from the resource document library by using the resource application template.

12. The non-transient storage media according to claim 11, wherein the providing a configuration interface to a user comprises:
providing configuration interfaces corresponding to the resource document type, the application operation, and the attribute field application respectively to the user.

13. The non-transient storage media according to claim 11, wherein the steps further comprises:
providing a resource document library modification interface to the user;
receiving modification information with respect to the resource document type and/or the document type field inputted by the user via the resource document library modification interface; and
synchronizing the modification information with the resource document library.

14. The non-transient storage media according to claim 13, wherein the synchronizing the modification information with the resource document library comprises:
generating a pseudo SQL statement according to the modification information;
converting the pseudo SQL statement into a query statement of the resource document library; and
modifying the structure of a data table in the resource document library by using the query statement.

15. The non-transient storage media according to claim 11, wherein the retrieving data from the resource document library by using the resource application template comprises:
retrieving data from the resource document library according to the resource document library and the document chosen by the user;
packaging the data into an object; and
invoking the object by using a page display template, so as to implement displaying with respect to the data in the object.
